(19) United States
(12) Patent Application Publication
(10) Pub. No.: US 2016/0037567 A1
(43) Pub. Date: Feb. 4, 2016

(54) CELLULAR FEEDBACK TRANSMISSION FOR USER EQUIPMENTS ENABLING DEVICE-TO-DEVICE COMMUNICATIONS

(71) Applicant: Microsoft Corporation, Redmond, WA (US)

(72) Inventors: Haipeng Lei, Beijing (CN); Zhi Zhang, Beijing (CN)

(21) Appl. No.: 14/502,814

(22) Filed: Sep. 30, 2014

(30) Foreign Application Priority Data
Jul. 31, 2014 (CN) 201410370852.X

(51) Int. Cl. H04W 76/02; H04W 72/04; H04L 5/00

(52) U.S. Cl. CPC H04W 76/023; H04L 5/0048; H04W 72/0446

(57) ABSTRACT

This disclosure generally relates to cellular feedback transmission for the user equipments enabling D2D communications. In one embodiment, the cellular uplink feedback and the D2D signals may be multiplexed in the same D2D subframe. For example, the feedback may be transmitted using a symbol that is not used to carry the D2D signal. In one embodiment, the feedback may be transmitted in the symbol that is kept as gap in the D2D subframe. By multiplexing the cellular feedback with the D2D signals, the cellular feedback can be transmitted to the BS without breaking off the D2D transmission.

### RELATED APPLICATIONS

This application claims priority to Chinese Application No. 201410370852.X, filed on Jul. 31, 2014, and entitled “CELLULAR FEEDBACK TRANSMISSION FOR USER EQUIPMENTS ENABLING DEVICE-TO-DEVICE COMMUNICATIONS.” This application claims the benefit of the above-identified application, and the disclosure of the above-identified application is hereby incorporated by reference in its entirety as if set forth herein in full.

### BACKGROUND

Major effort has been put in recent years on the development of Third Generation Partnership Project (3GPP) Long Term Evolution (LTE), which provides Evolved Universal Mobile Telecommunications System (UMTS) terrestrial radio access (EUTRA) and EUTRA network (EUTRAN) technology for higher data rates and system capacity.

In 3GPP LTE-Advanced (LTE-A) cellular systems, device-to-device (D2D) communication has been proposed to enable the proximity-based service. The D2D communication allows user equipments (UEs) to communicate with each other through a direct connection. In general, the D2D communication operates in uplink spectrum in the case of Frequency Division Duplex (FDD) or uplink subframes of the cell giving coverage. The D2D signals are communicated using Single Carrier Frequency Division Multiple Access (SC-FDMA).

In parallel with the D2D communications, the UEs may perform cellular communications with a base station (BS). From the perspective of the individual UEs, on any given carrier, the D2D signals and cellular signals are multiplexed using Time Division Multiplexing (TDM). In some cases, when receiving downlink information from the BS, it is necessary for the UE to provide uplink feedback. Specifically, the feedback is usually transmitted according to the predefined timing.

### SUMMARY

In current 3GPP LTE-A systems, for a D2D-enabled UE that works in the D2D transmission mode, the transmission of uplink cellular feedback may conflict with the D2D communications. By way of example, suppose that the downlink cellular transmission from a BS is received in the downlink subframe n and the UE shall report the positive or negative acknowledgement (ACK/NACK) in the uplink subframe n+4 to the BS according to predefined LTE FDD timing. In this event, no D2D signal can be transmitted in the uplink subframe n+4 due to the prioritization of cellular communication over the D2D communication, which will result in the performance loss of the D2D communication.

In order to avoid any potential performance degradation of the D2D communication, embodiments of the subject matter described herein provide a solution for feedback transmission for the UEs working in the D2D transmission mode. More specifically, the cellular feedback and the D2D signals may be multiplexed in a same subframe. In one embodiment, the cellular feedback may be transmitted using a symbol that is not used to transmit the D2D signal. For example, within the D2D subframe, the symbol that is initially kept as the D2D gap may be used to transmit the cellular feedback.

By multiplexing the cellular feedback with the D2D signals in a same subframe, the UE can transmit the cellular feedback to the BS without breaking off the D2D transmission. In this way, performance degradation of the D2D or cellular communications can be avoided. Additionally, the proposed mechanism for cellular feedback transmission has no impact on the D2D recipient UEs and will not introduce any resource waste in the cellular system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 illustrates a block diagram of user equipment in accordance with one embodiment of the subject matter described herein;

FIG. 2 illustrates a block diagram of an environment in which embodiments of the subject matter described herein may be implemented;

FIG. 3 illustrates a flowchart of a method for transmitting the cellular feedback at the UE side in accordance with one embodiment of the subject matter described herein;

FIGS. 4A-4C illustrates schematic diagrams of subframes in which the cellular uplink feedback and the D2D signals are multiplexed in accordance with one embodiment of the subject matter described herein;

FIG. 5 illustrates a flowchart of a method for receiving the cellular feedback at the BS side in accordance with one embodiment of the subject matter described herein;

FIG. 6 illustrates a block diagram of an apparatus for transmitting the cellular feedback at the UE side in accordance with one embodiment of the subject matter described herein; and

FIG. 7 illustrates a block diagram of an apparatus for receiving the cellular feedback at the UE side in accordance with one embodiment of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “base station” (BS) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) refers to any device that is capable of communicating with the BS. By way of example, the UE may include a terminal, a Mobile Terminal (MT), a Subscriber Station (SS), a Portable Subscriber Station (PSS), a Mobile Station (MS), or an Access Terminal (AT).

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

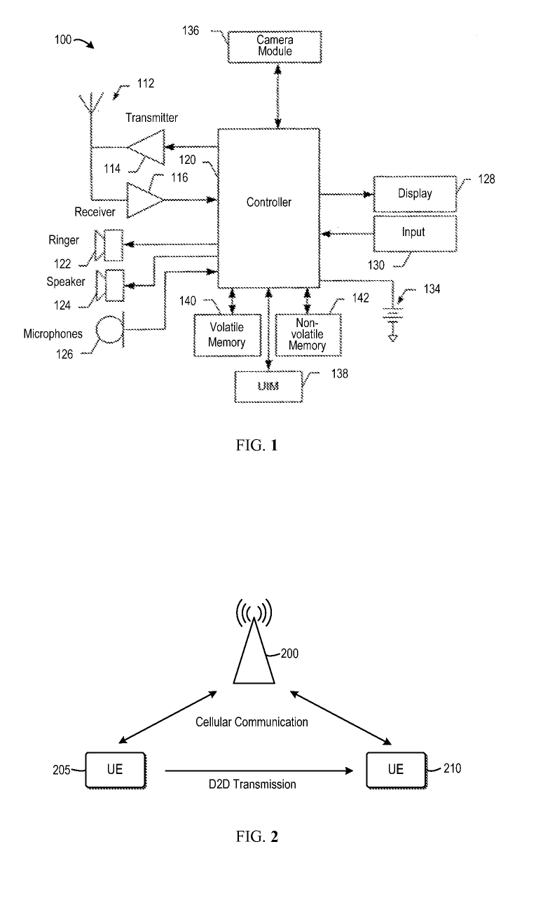

FIG. 1 illustrates a block diagram of a UE 100 in accordance with one embodiment of the subject matter described herein. The UE 100 may be a mobile device with a wireless communication capability. However, it is to be understood that any other types of user devices may also easily adopt embodiments of the subject matter described herein, such as a portable digital assistant (PDA), a pager, a mobile computer, a mobile TV, a game apparatus, a laptop, a tablet computer, a camera, a video camera, a GPS device, and other types of voice and textual communication system. A fixed-type device may likewise easily use embodiments of the subject matter described herein.

As shown, the UE 100 comprises one or more antennas 112 operable to communicate with the transmitter 114 and the receiver 116. With these devices, the UE 100 may perform cellular communications with one or more BSs. Additionally, the UE 100 may support the D2D communications with one or more other UEs.

The UE 100 further comprises at least one controller 120. It should be understood that the controller 120 comprises circuits or logic required to implement the functions of the UE 100. For example, the controller 120 may comprise a digital signal processor, a microprocessor, an A/D converter, a D/A converter, and/or any other suitable circuits. The control and signal processing functions of the UE 100 are allocated in accordance with respective capabilities of these devices.

The UE 100 may further comprise a user interface, which, for example, may comprise a ringer 122, a speaker 124, a microphone 126, a display 128, and an input interface 130, and all of the above devices are coupled to the controller 120. The UE 100 may further comprise a camera module 136 for capturing static and/or dynamic images.

The UE 100 may further comprise a battery 134, such as a vibrating battery set, for supplying power to various circuits required for operating the UE 100 and alternatively providing mechanical vibration as detectable output. In one embodiment, the UE 100 may further comprise a user identification module (UIM) 138. The UIM 138 is usually a memory device with a processor built in. The UIM 138 may for example comprise a subscriber identification module (SIM), a universal integrated circuit card (UICC), a universal user identification module (USIM), or a removable user identification module (R-UIM), etc. The UIM 138 may comprise a card connection detecting apparatus according to embodiments of the subject matter described herein.

The UE 100 further comprises a memory. For example, the UE 100 may comprise a volatile memory 140, for example, comprising a volatile random access memory (RAM) in a cache area for temporarily storing data. The UE 100 may further comprise other non-volatile memory 142 which may be embedded and/or movable. The non-volatile memory 142 may additionally or alternatively include for example, EEPROM and flash memory, etc. The memory may store any item in the plurality of information segments and data used by the UE 100 so as to implement the functions of the UE 100. For example, the memory may contain machine-executable instructions which, when executed, cause the controller 120 to implement the method described below.

It should be understood that the structural block diagram in FIG. 1 is shown only for illustration purpose, without suggesting any limitations on the scope of the subject matter described herein. In some cases, some devices may be added or reduced as required.

FIG. 2 shows an environment of a cellular system in which embodiments of the subject matter described herein may be implemented. As shown, one or more UEs may communicate with a BS 200. In this example, there are two UEs 205 and 210. This is only for the purpose of illustration without suggesting limitations on the number of UEs. There may be any suitable number of UEs in communication with the BS 200. The UEs 205 and/or 210 may be implemented by the UE 100 as described above, for example. The cellular communications between the UEs 205 and 210 and the BS 200 may be performed according to any appropriate communication protocols including, but not limited to, the first generation (1G), the second generation (2G), 2.5G, 2.75G, the third generation (3G), the fourth generation (4G) communication protocols, and/or any other protocols either currently known or to be developed in the future.

The UEs 205 and 210 may perform D2D communications with one another. In the example shown in FIG. 2, only for the purpose of illustration, the UE 205 works in the D2D transmission mode while the UE 210 works in the D2D reception mode. That is, the UE 205 may transmit D2D signals to the UE 210. From the perspective of the UE 205, on any given carrier, the D2D signals and cellular signals are multiplexed using TDM.

Traditionally, if the UE 205 receives downlink information from the BS 200 that requires feedback, the UE 205 has to stop the D2D transmission to the UE 210 when sending the uplink feedback to the BS 200. Considering the fact that the D2D transmission in usually a slow scale service, it has large impact on the D2D communication between the UEs 205 and 210. However, if the D2D data broadcasting is prioritized over the cellular feedback transmission, the base station 200 may initiate unnecessary downlink retransmission which results in downlink performance loss.

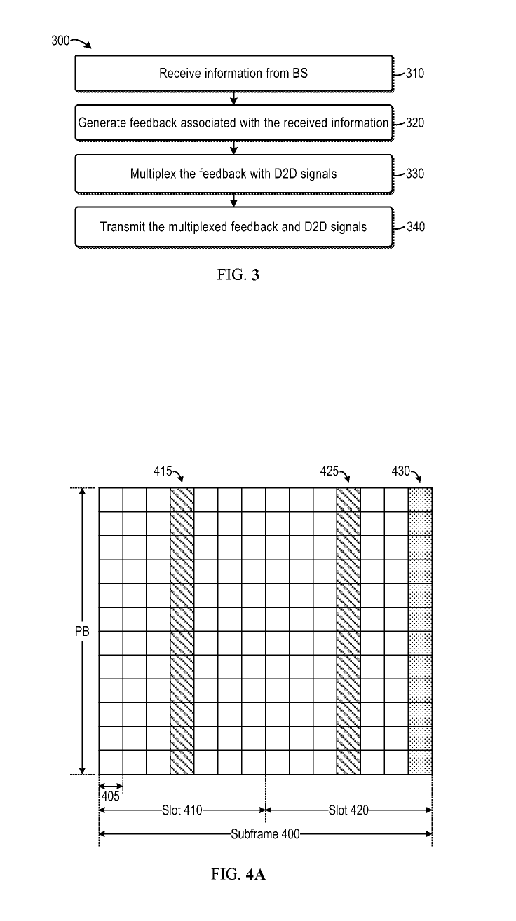

FIG. 3 shows the flowchart of a method 300 for cellular feedback transmission in accordance with one embodiment of the subject matter described herein. The method 300 may be at least in part implemented by the UE 205 that works in the D2D transmission mode, for example.

The method 300 is entered at step 310, where downlink information is received from the BS 200, for example, by use of the one or more receivers 116 of the UE 205. By way of example, in one embodiment, the information received at step 310 may include data transmitted on a downlink data channel such as Physical Downlink Shared Channel (PDSCH). Alternatively or additionally, the received information may include control information transmitted on a downlink control channel such as Physical Downlink Control Channel (PDCCH). In one embodiment, the downlink control information may indicate the release of downlink Semi-Persistent Scheduling (SPS), for example. Of course, it is also possible to receive any additional or alternative information at step 310.

Responsive to receipt of the downlink information, at step 320, the controller 120 of the UE 205 is configured to generate feedback depending on a determination whether the information is correctly received. For example, it is possible to verify the received information by applying the cyclic redundancy check (CRC) or any other suitable processes. In one embodiment, the feedback may include ACK/NACK information. That is, if it is determined that the information is correctly received, the controller 120 is configured to generate a positive acknowledgment (ACK). On the contrary, if the UE 205 determines that the information is not correctly received, a negative acknowledgement (NACK) may be generated by the controller 120. It is to be understood that ACK/NACK is just an example of the feedback, without suggesting any limitations on the subject matter described herein. The feedback generated at step 320 may include any additional or alternative information.

The method 300 then proceeds to step 330, where the cellular feedback is multiplexed with the D2D signals to be transmitted. As discussed above, traditionally when it is required to transmit the uplink cellular feedback, the UE 205 has to stop the transmission of relevant D2D signals (if any). For example, in the 3GPP LTE-A system, upon receiving information on PDSCH or PDCCH indicating the downlink SPS release in the downlink subframe n, the UE 205 shall report the corresponding feedback according the predefined downlink Hybrid Automatic Repeat Request (HARQ) timing. Specifically, the UE 205 will transmit the feedback in an uplink subframe n+m, where m is set to 4 for FDD. Then, due to the prioritization of the cellular communication over the D2D communication, no D2D signal can be transmitted in the subframe n+4. As a result, any D2D recipient UE within the coverage of the UE 205, for example, the UE 210 as shown in FIG. 2, will lose one opportunity in the reception.

Contrary to such conventional solutions, in accordance with embodiments of the subject matter described herein, the cellular feedback such as the ACK/NACK information may be multiplexed or combined with the D2D signals. In this way, it is possible to enable the cellular feedback transmission without interrupting the D2D transmission. In one embodiment, TDM may be used to combine the cellular feedback and the D2D signals. More specifically, in such embodiment, the cellular feedback and the D2D signals are multiplexed in a same D2D subframe. As used herein, the term “D2D subframe” refers to any subframe that is used to transmit the D2D signals.

In one embodiment, the UE 205 may select a suitable D2D subframe according to the predefined downlink HARQ timing. For example, in the example described above where the UE 205 receives the PDSCH or PDCCH information indicating the downlink SPS release in the subframe n, the subframe n+m may be selected according to the downlink HARQ timing, such that the UE 205 simultaneously transmits the D2D signals and the uplink cellular ACK/NACK feedback in the selected subframe n+m.

In one embodiment, the cellular feedback may be transmitted using the symbol in the D2D subframe that is kept as a D2D gap, that is, the gap for D2D communications. As known, within a D2D subframe, there may be a symbol(s) that is not used to transmit any D2D signals. Such symbol is used as the D2D gap between different D2D subframes to avoid potential interference. For example, in one embodiment, the end symbol in each D2D subframe may be kept as the D2D gap. Alternatively or additionally, the start symbol may be used as the D2D gap. In the following discussions, the end symbol within the D2D subframe will be described as the D2D gap. This is merely for the purpose of illustration, without suggesting any limitations on the subject matter described herein. In alternative embodiments, any suitable symbol(s) in the D2D subframe may be kept as the D2D gap.

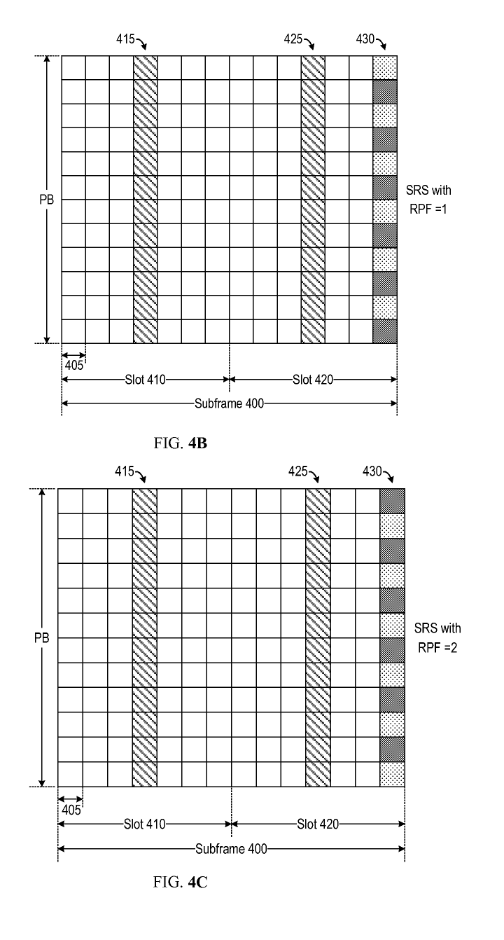

For the purpose of illustration, FIG. 4A shows a schematic diagram of a subframe 400 of a resource block (RB). By way of example, in this embodiment, the D2D subframe 400 may contain fourteen (14) symbols 405 and may be of a length of 1 ms. The subframe 400 contains two slots 410 and 420, each of a length of 0.5 ms in this example. The slots 410 and 420 may contain a Physical Uplink Shared Channel (PUSCH) Demodulation Reference Signal (DM RS) 415 and 425, respectively.

In this embodiment, the last symbol 430 of the subframe 400 is kept as the D2D gap. That is, in the conventional solutions, the symbol 430 will not be used to transmit any D2D signals. In accordance with embodiments of the subject matter described herein, the symbol 430 is used to transmit the uplink cellular feedback generated at step 320. The other symbols in the D2D subframe 400 may be used to transmit the D2D signals. As such, the uplink cellular feedback and the D2D signals are multiplexed in the same D2D subframe 400.

The symbol 430 may be used to transmit a signal capable of indicating the content or status of the feedback. For example, when the feedback includes the ACK/NACK information, the symbol 430 may be used to transmit a signal that indicates at least two states that are corresponding to the positive acknowledgement (ACK) and negative acknowledgement (NACK), respectively.

By way of example, in one embodiment, a sounding reference signal (SRS) with two different repetition factors (RPFs) may be generated as the uplink cellular feedback and transmitted in the symbol 430 of the D2D subframe 400. Specifically, in response to a determination that the information is correctly received at step 310, the SRS with a first RPF may be transmitted. As an example, in one embodiment where the SRS is implemented as a comb-type signal, it is possible to set RPF=1 to transmit the odd-comb SRS to indicate the positive acknowledgement, as shown in FIG. 4B. On the other hand, if it is determined that the information is incorrectly received at step 310, the SRS with a different second RPF may be generated and transmitted. For the comb-type SRS, the RPF may be set to 2 such that the even-comb SRS is used to indicate the negative acknowledgement, as shown in FIG. 4C.

It is to be understood that the use of comb-type SRS is merely for the purpose of illustration, without suggesting any limitations on the subject matter described herein. For example, in another embodiment, a non-comb SRS may be used to implement the cellular feedback. In fact, any other appropriate signals or patterns may be transmitted in the symbol 430 to indicate the positive or negative acknowledgment and/or any other feedback information.

Using the D2D gap in the subframe to transmit the uplink cellular feedback would be beneficial. Since the D2D gap carries no D2D signal, the recipient UE will not detect this symbol. Therefore, the transmission of the cellular feedback in the D2D gap will put no impact on the D2D recipient UEs. Moreover, there is no need for any additional resource to implement the cellular feedback transmission.

However, it is to be understood that it is not necessarily required to transmit the cellular feedback in the D2D gap. For example, in another embodiment, any one or more symbols in the D2D subframe that are initially used to carry the D2D signals may be adapted to transmit the cellular feedback. In such embodiment, the D2D recipient UEs may be informed not to detect the signals transmitted in these symbols, for example.

Still with reference to FIG. 3, at step 340, the cellular feedback and the D2D signals, which are multiplexed in a single D2D subframe, are simultaneously transmitted. The D2D subframe may be broadcasted by the transmitter 114 of the UE 205, such that other UEs located in the coverage range of the UE 205 (for example, the UE 210 as shown in FIG. 2) may receive the D2D subframe. Traditionally the BS 200 is unnecessary to receive and detect such D2D subframe. In accordance with embodiments of the subject matter described herein, in the case that the BS 200 schedules the downlink subframe by transmitting the information to the UE 205, the BS 200 may receive the D2D subframe transmitted from the UE 205, for example, according the HARQ timing. Then the feedback information may be detected from the D2D subframe, for example, from the D2D gap without interrupting or otherwise affecting the D2D transmissions.

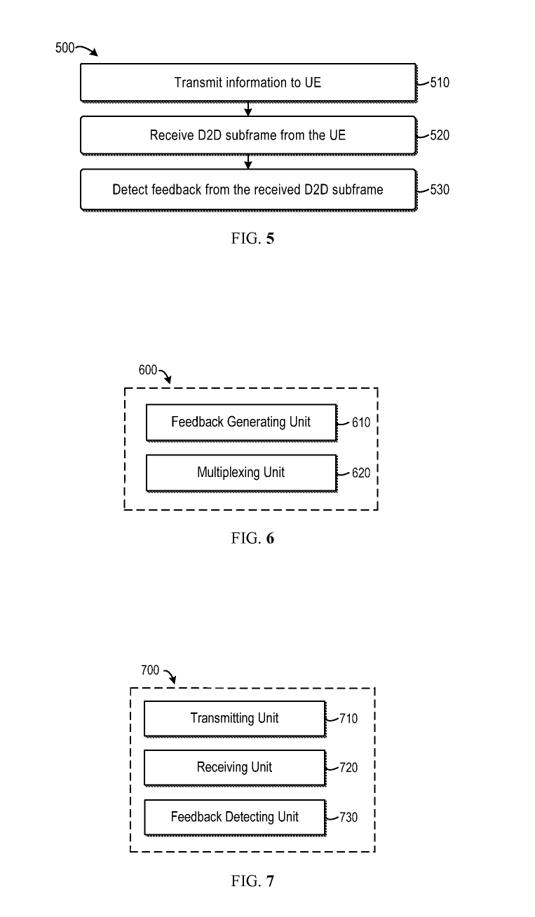

FIG. 5 illustrates a flowchart of a method 500 for feedback receipt at the BS side in accordance with one embodiment of the subject matter described herein. The method 500 may be at least in part implemented by the BS 200 in the cellular system.

The method 500 is entered at step 510 where the information is transmitted by the BS 200 to the UE 205. As described above, the BS 200 may transmit data and/or control information to the UE 205. For example, in one embodiment, data may be transmitted to the UE 205 on a downlink data channel such as PDSCH. Alternatively or additionally, the BS 200 may transmit control information on a downlink control channel such as PDCCH to indicate the SPS release, for example.

At step 520, the BS 200 receives a D2D subframe transmitted from the UE 205. As discussed above, the D2D subframe contains not only the D2D signals, but also the cellular feedback associated with the information transmitted at step 510. In one embodiment, in order to detect the cellular feedback, it is only necessary for the BS 200 to receive the D2D subframe that is determined according to the predefined timing. For example, if the downlink information is transmitted in the subframe n and the HARQ timing specifies that the feedback shall be sent back after m subframes, then the BS 200 only needs to receive the subframe n+m transmitted by the UE 205 to obtain the cellular feedback. Of course, it is also possible for the BS 200 to receive one or more additional subframes transmitted from the UE 205.

Next, at step 530, the BS 200 detects, from the received D2D subframe, the feedback associated with the information transmitted at step 510. As discussed above, in one embodiment, the feedback such as the ACK/NACK may be transmitted using the D2D gap in the D2D subframe. For example, in one embodiment where the end symbol in the subframe serves as the D2D gap, the BS 200 may detect the signal transmitted in the end symbol to obtain the feedback. By way of example, as described above, the feedback may be indicated by a SRS with different RPFs. In such embodiment, the BS 200 may detect the SRS RPF to determine whether the information is correctly received at the UE 205. In this way, the cellular communications between the UE 205 and BS 200 may be performed without causing any performance degradation in the D2D communications.

FIG. 6 shows a block diagram of an apparatus 600 for transmitting the cellular feedback at the UE side. As shown, the apparatus 600 comprises a feedback generating unit 610 configured to generate, responsive to receiving information from a base station in a cellular system, feedback associated with the received information. The apparatus 600 further comprises a multiplexing unit 620 configured to multiplex the feedback with a D2D signal for transmission.

In one embodiment, the multiplexing unit 620 is configured to indicate the feedback using a symbol in a subframe for transmitting the D2D signal, where the symbol is kept as a D2D gap. By way of example, the symbol may be the last symbol in the subframe. In one embodiment, the multiplexing unit 620 is configured to multiplex the feedback with the D2D signal in the subframe according to predefined downlink HARQ timing. That is, the subframe for multiplexing the D2D signal and the feedback may be determined according to the downlink HARQ timing.

In one embodiment, the feedback generating unit 610 comprises a SRS generating unit configured to generate a SRS as the feedback. In one embodiment, the SRS generating unit is configured to generate the SRS with a first RPF responsive to determining that the information is correctly received, and to generate the SRS with a second RPF that is different from the first RPF responsive to determining that the information is incorrectly received or vice versa.

In one embodiment, the received information includes data received on a downlink data channel, or control information received on a downlink control channel that indicates the downlink SPS release. In one embodiment, the feedback includes ACK/NACK information.

FIG. 7 shows a block diagram of an apparatus 700 for receiving the cellular feedback at the BS side. In one embodiment, the apparatus 700 may be the BS 200 per se, for example. As shown, the apparatus 700 comprises: a transmitting unit 710 configured to transmit information to a UE; a receiving unit 720 configured to receive from the UE a subframe that is used to transmit D2D signals; and a feedback detecting unit 730 configured to detect feedback associated with the transmitted information from the received subframe.

In one embodiment, the receiving unit 720 is configured to receive the subframe according to predefined downlink HARQ timing. In one embodiment, the feedback detecting unit 730 is configured to detect the feedback from a symbol in the subframe that is kept as a gap for D2D communications. In one embodiment, the symbol is the last symbol in the subframe. In one embodiment, the feedback detecting unit 730 is configured to detect the SRS RPF in the received subframe, for example, in the last symbol kept as the D2D gap. In one embodiment, the feedback includes ACK/NACK information.

The units included in the apparatuses 600 and/or 700 may be implemented in various manners, including software, hardware, firmware, or any combination thereof. In one embodiment, one or more units may be implemented using software and/or firmware, for example, machine-executable instructions stored on storage medium. In addition to or instead of machine-executable instructions, parts or all of the units in the apparatuses 600 and/or 700 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method implemented at least in part by user equipment comprising:
responsive to receiving information from a base station in a cellular system, generating feedback associated with the received information; and
multiplexing the feedback with a device-to-device (D2D) signal in a subframe for transmission.

2. The method of claim 1, wherein multiplexing the feedback with the D2D signal comprises:
indicating the feedback using a symbol in the subframe, the symbol being kept as a gap for D2D communications.

3. The method of claim 2, wherein the symbol is an end symbol in the subframe.

4. The method of claim 1, further comprising:
determining the subframe for multiplexing the feedback and the D2D signal according to predefined downlink Hybrid Automatic Repeat Request (HARQ) timing.

5. The method of claim 1, wherein generating the feedback comprises:
generating a sounding reference signal (SRS) as the feedback.

6. The method of claim 5, wherein generating the SRS comprises:
responsive to determining that the information is correctly received, generating the SRS with a first repetition factor (RPF); and
responsive to determining that the information is incorrectly received, generating the SRS with a second RPF that is different from the first RPF.

7. The method of claim 1, wherein the received information includes data received on a downlink data channel, or control information received on a downlink control channel that indicates a release of downlink Semi-Persistent Scheduling (SPS).

8. The method of claim 1, wherein the feedback includes ACK/NACK information.

9. A method implemented at least in part by a base station comprising:
transmitting information to user equipment;
receiving, from the user equipment, a subframe for transmitting a device-to-device (D2D) signal; and
detecting feedback associated with the transmitted information from the received subframe.

10. The method of claim 9, wherein receiving the subframe comprises:
receiving the subframe according to predefined downlink Hybrid Automatic Repeat Request (HARQ) timing.

11. The method of claim 9, wherein detecting the feedback comprises:
detecting the feedback from a symbol in the subframe, the symbol being kept as a gap for D2D communications.

12. The method of claim 11, wherein the symbol is an end symbol in the subframe.

13. The method of claim 9, wherein detecting the feedback comprising:
detecting a repetition factor (RPF) of a sounding reference signal (SRS) in the received subframe.

14. The method of claim 9, wherein the feedback includes ACK/NACK information.

15. User equipment comprising:
a receiver configured to receive information from a base station in a cellular system;
a controller configured to generate feedback associated with the received information and to multiplex the feedback with a device-to-device (D2D) signal in a subframe; and
a transmitter configured to transmit the subframe.

16. The user equipment of claim 15, wherein the controller is configured to multiplex the feedback with the D2D signal by indicating the feedback using a symbol in the subframe, the symbol being kept as a gap for D2D communications.

17. The user equipment of claim 16, wherein the symbol is an end symbol in the subframe.

18. The user equipment of claim 15, wherein the controller is configured to select the subframe according to predefined downlink Hybrid Automatic Repeat Request (HARQ) timing.

19. The user equipment of claim 15, wherein the controller is configured to:
responsive to determining that the information is correctly received, generate a sounding reference signal (SRS) with a first repetition factor (RPF) as the feedback; and
responsive to determining that the information is incorrectly received, generate the SRS with a second RPF as the feedback, the second RPF being different from the first RPF.

20. The user equipment of claim 15, wherein the feedback includes ACK/NACK information.
